(19) United States
(12) Patent Application Publication
(10) Pub. No.: US 2004/0160183 A1
(43) Pub. Date: Aug. 19, 2004

(54) Display apparatus with a PDP

(75) Inventor: Jae-young Kim, Suwon-city (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/703,110

(22) Filed: Nov. 7, 2003

(30) Foreign Application Priority Data
Nov. 7, 2002 (KR) 2002-68627

(51) Int. Cl. H01J 17/49

(52) U.S. Cl. 313/582

(57) ABSTRACT

A display apparatus with a PDP is disclosed. The display apparatus includes a panel assembly accommodated in a case having a front substrate, electrode layers and a rear substrate; a driver provided between the case and the panel assembly to drive the electrode layers; an electromagnetic wave shield layer being a transparent thin film formed through evaporation, having a predetermined size, and attached on the top surface of the front substrate shielding electromagnetic waves generated from the electrode layers; a reflection-preventing film built up on the top surface of the electromagnetic wave shield layer cutting off noise signals of light emitted from the panel assembly; a cover coupled over the reflection-preventing film in contact with a predetermined stepped area of the panel assembly; and electrode connectors provided in a predetermined area of the electromagnetic wave shield layer electrically connecting the driver, panel assembly, electromagnetic wave shield layer, cover, and case.

### CROSS-REFERENCE TO RELATED APPLICATIONS

This application claims the benefit of Korean Application No. 2002-68627, filed Nov. 7, 2002, in the Korean Intellectual Property Office, the disclosure of which is incorporated herein by reference.

### BACKGROUND

1. Field of the Invention

The present invention relates to a display apparatus with a plasma display panel (PDP) (hereinafter, referred to as a PDP display apparatus or plasma display apparatus), and more particularly, to a PDP display apparatus provided with a conductive film for blocking electromagnetic waves.

2. Description of the Related Art

The plasma display panel (PDP) is a flat display device using gas discharge phenomena. A PDP display apparatus is easily formed to be thinner, more light-weight, and larger when compared to a cathode ray tube (CRT) display apparatus, and is spotlighted as a next generation display apparatus.

FIG. 1 is a view for schematically showing a conventional plasma display apparatus.

In FIG. 1, a plasma display apparatus 100 has a case 110, a cover 120, a driver 130, a panel assembly 140, and a filter 150.

The plasma display apparatus 100 uses a PDP to display images.

The driver 130, panel assembly 140, and filter 150 are accommodated between the case 110 and the cover 120.

The driver 130 controls the overall driving of the plasma display apparatus 100. For example, the driver 130 applies driving voltages to electrode layers (not shown) formed in the panel assembly 140 to be described later, and drives the electrode layers.

The panel assembly 140 as a PDP has a rear substrate 142, a front substrate 144, and electrode layers (not shown). The electrode layers (not shown) are formed between the rear substrate 142 and the front substrate 144.

The filter 150 is provided to be spaced in a certain interval from the front substrate 144 of the panel assembly 140. The filter 150 blocks an external leakage of electromagnetic waves occurring upon the driving of the panel assembly 140.

FIG. 2 is a cross-sectioned view of a filter shown in FIG. 1.

FIG. 2 is a cross-section view of the filter taken along the line A-A of FIG. 1. In FIG. 2, the filter 150 has a first anti-reflection (AR) film 152, an electromagnetic wave shield layer 154, a power connector 156, tempered glass 158, and a second AR film 159.

The first and second AR films 152 and 159 blocks near infrared rays and neon light from light emitted from the panel assembly 140, and prevents the reflection of light for image signals. Accordingly, the light reflection rate for image signals decreases, and the gradation is enhanced. The first AR film 152 faces the outer surface of the front substrate 144, and the second AR film 159 is externally exposed.

The transparent conductive coat (not shown) of electromagnetic wave shield layer 154 is formed through sputtering in a planar shape with copper or silver (Ag). Further, the electromagnetic wave shield layer 154 can be formed in an etching mesh type process. The etching mesh type process processes a special chemical substance by photolithographic etching to form a photomask substrate.

The power connector 156 is provided on the edge of the electromagnetic wave shield layer 154. Accordingly, the electromagnetic wave shield layer 154 is electrically connected to the cover 120, panel assembly 140, and case 110 to fabricate electrodes.

The tempered glass 158 protects the plasma display apparatus 100 from external shocks and provides a clearer image quality.

With reference to FIG. 1 for descriptions, the electromagnetic waves generated from the panel assembly 140 due to an applied voltage from the driver 130 are shielded by the electrodes fabricated from the electromagnetic wave shield layer 154. That is, the generated electromagnetic waves pass to the ground via the cover 120 and the case 110 from the electromagnetic wave shield layer 154.

However, inconvenience may be caused since the conventional plasma display apparatus 100 is separately provided with filter 150 to shield the electromagnetic waves generated from the panel assembly 140. Because the filter 150 is spaced apart a certain interval from the panel assembly 140, electromagnetic wave shielding rate becomes irregular according to the arrangement of the filter 150. Further, a receiver (not shown) may have unstable operations due to near infrared rays generated upon the discharging of the panel assembly 140.

### SUMMARY

In order to solve the above problems, it is an aspect of the present invention to provide a plasma display apparatus having a conductive film formed on a plasma display panel to enable the shield of electromagnetic waves.

In order to achieve the above aspect and/or other features of the present invention, a display apparatus with a plasma display panel (PDP) comprises a panel assembly, a driver, an electromagnetic wave shield layer, a reflection-preventing film, a cover, and electrode connectors. The panel assembly is accommodated in a case and having a front substrate, electrode layers, and a rear substrate. The driver is provided between the case and the panel assembly to drive the electrode layers. The electromagnetic wave shield layer is a transparent thin film formed through evaporation and attached in a predetermined size or thickness on the top surface of the front substrate, to shield electromagnetic waves generated from the electrode layers. The reflection-preventing film is built up on the top surface of the electromagnetic wave shield layer, to cut off noise signals of light emitted from the panel assembly. The cover is coupled over the reflection-preventing film to come in contact with a predetermined stepped area of the panel assembly, and the electrode connectors are provided in a predetermined area of the electromagnetic wave shield layer, electrically connecting the driver, the panel assembly, the transparent conductive coat, the cover, and the case in order for the electromagnetic wave shield layer to shield the electromagnetic waves. The driver, the panel assembly, the electromagnetic wave shield layer, the reflection-preventing film, and the cover are built up in the recited order from the case.

In more detail, the power connectors are provided at the edge area of the electromagnetic wave shield layer.

Further, the reflection-preventing film cuts off near infrared rays emitted from the panel assembly, and prevents the reflection of light for image signals out of emitted light.

In the meantime, according to an exemplary embodiment of the present invention, a display apparatus with a PDP comprises a driver, a metal conductive mesh, a reflection-preventing film, a cover, and electrode connectors. The driver is provided between a case and a panel assembly to drive electrode layers. The metal conductive mesh is obtained from metal processed into a mesh shape through etching, and attached in a predetermined size or thickness on an outer surface of the front substrate, to shield electromagnetic waves generated from the electrode layers. The reflection-preventing film is built up on an outer surface of the metal conductive mesh, to cut off noise signals of light emitted from the panel assembly. The cover is coupled to come in contact with a predetermined stepped area of the panel assembly; and electrode connectors provided at a predetermined area of the metal conductive mesh, and electrically connecting the driver, the panel assembly, the metal conductive mesh, the cover, and the case in order for the metal conductive mesh to shield the electromagnetic waves. The driver, the panel assembly, the metal conductive mesh, the reflection-preventing film, and the cover are built up in the recited order from the case.

### BRIEF DESCRIPTION OF THE DRAWINGS

The invention will be described in detail with reference to the following drawings in which like reference numerals refer to like elements, and wherein:

FIG. 1 is a view for schematically showing a conventional plasma display apparatus;

FIG. 2 is a cross-sectioned view of a filter of FIG. 1;

FIG. 3 is a view for schematically showing a plasma display apparatus according to an exemplary embodiment of the present invention;

FIG. 4 is a perspective view for partially showing a panel assembly of FIG. 3;

FIG. 5 is a cross-sectioned view of the panel assembly, electromagnetic wave shield layer, and AR films of FIG. 3; and

FIG. 6 is a cross-sectioned view of the panel assembly, a metal conductive mesh, electromagnetic wave shield layer, and AR films of FIG. 3.

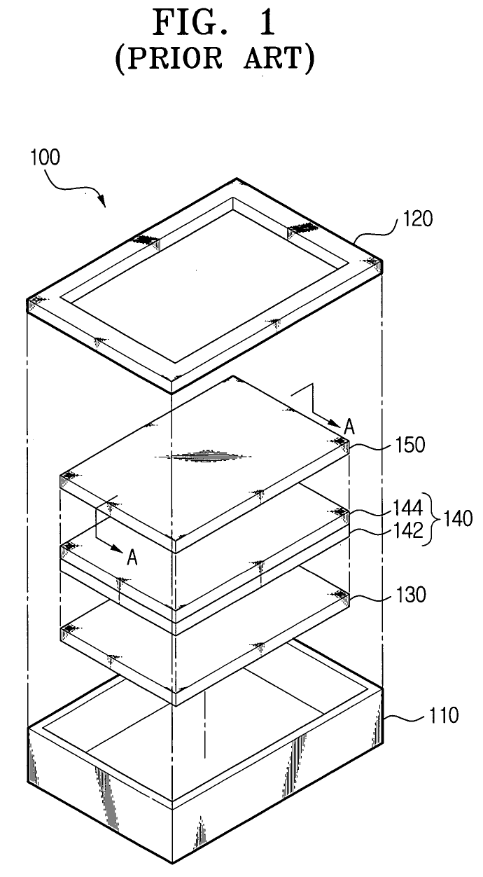

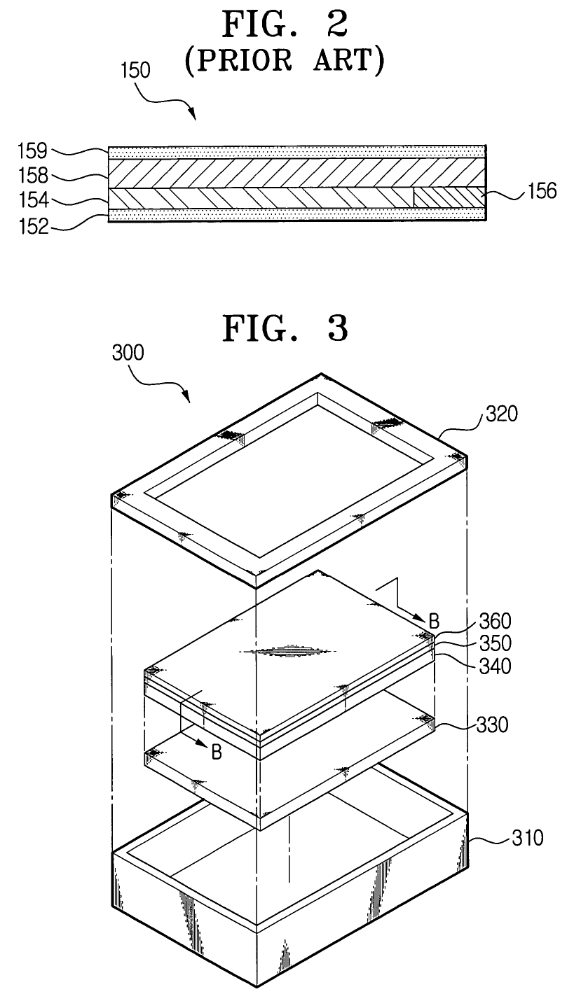

### DETAILED DESCRIPTION OF AN EXEMPLARY EMBODIMENT

Hereinafter, the present invention will be described in detail with reference to the accompanying drawings.

FIG. 3 is a view for schematically showing a plasma display apparatus according to an exemplary embodiment of the present invention.

In FIG. 3, a plasma display apparatus 300 according to the present invention has a case 310, a cover 320, a driver 330, a panel assembly 340, an electromagnetic wave shield layer 350, and a reflection-preventing film 360.

The plasma display apparatus 300 uses a plasma display panel (PDP) to display images.

The driver 330, panel assembly 340, electromagnetic wave shield layer 350, and reflection-preventing film 360 are accommodated between the case 310 and the cover 320.

The driver 330 is provided between the case 310 and the panel assembly 340 to be described later, and controls the overall driving of the plasma display apparatus 300. For example, the driver 330 applies a driving voltage to the electrode layers 342a and 342b formed on the panel assembly 340 and drives the electrode layers 342a and 342b.

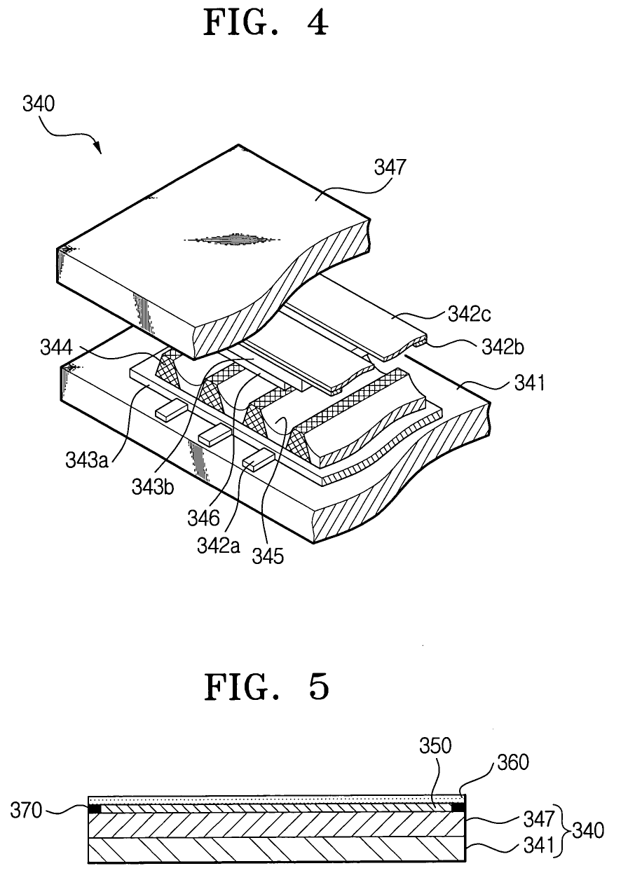

FIG. 4 is a perspective view for partially showing a panel assembly of FIG. 3.

In FIG. 4, the panel assembly 340 as a PDP has a rear substrate 341, a plurality of first electrode layers 342a, a first dielectric layer 343a, plural partition walls 344, plural cells 345, a protection film 346, a second dielectric layer 343b, a plurality of second electrode layers 342b, a plurality of transparent electrode layers 342c, and a front substrate 347.

The rear and front substrates 341 and 347 are formed of a transparent substance such as glass or transparent synthetic resin.

A plurality of first and second electrode layers 342a and 342b are formed between the rear and front substrates 341 and 349, at a right angle with each other.

The plurality of first electrode layers 342a are address electrodes.

The first dielectric layer 343a is coated on the overall rear substrate 341 to isolate the first electrode layers 342a from each other. The plural partition walls 344 are formed on the top surface of the first dielectric layer 343a, and a fluorescent material is coated on the certain areas of the partition walls 344. Further, cells 345 are formed among the partition walls 344, and discharging gas such as Ar, Ne, or Xe are filled in the cells 345. The partition walls 344 prevent the crosstalk between cells 345.

Further, a fluorescent material is coated on certain areas of the partition walls 344 and the first dielectric layer 343a, for the colorization of the panel assembly 340.

The second electrode layers 342b are bus electrodes and the transparent electrode layers 342c are electrodes of Indium Tin Oxide (ITO) substance.

The second dielectric layer 343b charges electric charges occurring between the second electrode layers 342b and the transparent electrode layers 342c. The protection film 346 protects the second electrode layers 342b and the transparent electrode layers 342c.

The panel assembly 340 as above generates certain electromagnetic waves as the electrode layers 342a and 342b are driven by the driver 330. The generated electromagnetic waves induce the electromagnetic interference (EMI) phenomenon. The electromagnetic interference (EMI) phenomenon is a phenomenon in which the operations of external devices are obstructed by generated electromagnetic waves.

The electromagnetic wave shield layer 350 is provided to prevent the external leakage of such electromagnetic waves. And the electromagnetic shield layer 350 includes a transparent conductive coat.

FIG. 5 is a cross-sectioned view of the panel assembly, electromagnetic wave shield layer, and an anti-reflection film of FIG. 3, and a power connector.

The cross-sectioned view of FIG. 5 is one taken along the arrow directions indicated by the lines B-B of FIG. 3, showing the panel assembly 340, the electromagnetic wave shield layer 350, the electrode connectors 370, and the reflection-preventing film 360. Further, in FIG. 5, the panel assembly 340 has the rear substrate 341 and the front substrate 347, and the other constituents for the panel assembly 340 will be omitted for the sake of descriptions.

The electromagnetic wave shield layer 350 is formed through evaporation into a transparent and thin film having good conductivity. The electromagnetic wave shield layer 350 is attached in a predetermined size on the top surface of the front substrate 347. The electromagnetic wave shield layer 350 is, in an alternative exemplary embodiment, deposited through sputtering over the entire surface of the front substrate 347.

The electrode connectors 370 (shown in black) are provided the opposing edge portions of the electromagnetic wave shield layer 350. By the electrode connectors 370, the electromagnetic wave shield layer 350 is electrically connected with the cover 320, the ground (not shown) of the driver 330, the panel assembly 340, the case 310, and the ground (not shown) of the electrode connectors 370, to shield the electromagnetic waves generated from the electrode layers 342a, 342b.

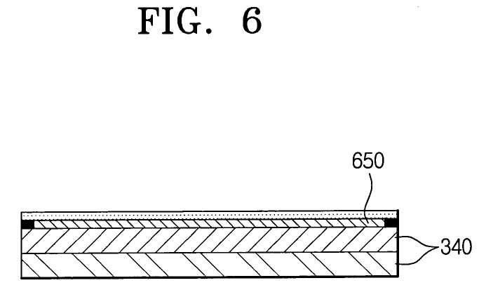

Alternatively, in another embodiment, in FIG. 6, a metal conductive mesh 650 is used in lieu of the electromagnetic wave shield layer 350. The metal conductive mesh 650 is one that is formed of a specific conductive substance such as gold, silver, copper, or the like which is machined through photo engraving etching. Using the metal conductive mesh 650, electromagnetic waves generated from the panel assembly 340 are shielded.

The reflection-preventing film 360 is built up on the top surface of the electromagnetic wave shield layer 350. The reflection-preventing film 360 cuts off noise components and near infrared rays, for example, of wavelengths of 78 nm˜250 nm out of light emitted from the panel assembly 340.

The noise components belong to a range from 630 nm to 640 nm wavelengths, which may be typically the orange color having about 635 nm wavelength. Further, by cutting off the near infrared rays, it is possible to prevent the occurrence of errors at a receiving part of a receiver (not shown) due to the near infrared rays, i.e., prevent the receiver from receiving near infrared rays emitted from the panel assembly 340 that are not intended for the receiver. The receiving part of a receiver (not shown) is provided in the plasma display apparatus 300 to externally receive infrared signals.

Further, the reflection-preventing film 360 prevents the reflection of light of image signals from light emitted from the panel assembly 340, and decreases the irregular reflection rate of external light. According to this, the gradation of images becomes improved.

Such a reflection-preventing film 360 is formed by laminating an anti-reflection (AR) film or by a coating process of special paint.

Back to FIG. 3, the cover 320 is provided on the top surface of the reflection-preventing film 360. The cover 320 is provided to come in contact with a predetermined stepped area of the panel assembly 340. The cover 320, driver 330, panel assembly 340, and case 310 are electrically connected with the electromagnetic wave shield layer 350 through the electrode connectors 370. According to this, the electromagnetic waves generated from the panel assembly 340 are shielded by the electrodes fabricated on the electromagnetic wave shield layer 350. That is, the generated electromagnetic waves are picked up by the electromagnetic wave shield layer 350, and then are grounded to the cover 320 and the case 310.

The plasma display apparatus 300 according to the present invention can shield the electromagnetic waves occurring from a PDP without any extra filter. In other words, the EMI can be effectively cut off by attaching a conductive film by evaporating a transparent thin coat on the front substrate of a PDP or forming an etched metal in a mesh shape. According to this, the manufacturing cost reduction and slimmer shape of the plasma display apparatus can be achieved.

While the invention has been shown and described with reference to a certain exemplary embodiment thereof, it will be understood by those skilled in the art that various changes in form and details may be made therein without departing from the spirit and scope of the invention as defined by the appended claims.

What is claimed is:

1. A display apparatus with a plasma display panel (PDP), comprising:
a panel assembly accommodated in a case;
a driver provided between the case and the panel assembly to drive the panel assembly;
an electromagnetic wave shield layer being a thin film transparent conductive coat attached in a predetermined size on a top surface of the panel assembly, shielding electromagnetic waves generated from the panel assembly;
a reflection-preventing film disposed on the top surface of the electromagnetic wave shield layer, cutting off noise signals of light emitted from the panel assembly;
a cover coupled over the reflection-preventing film in contact with a predetermined stepped area of the panel assembly; and
electrode connectors disposed at predetermined areas of the electromagnetic wave shield layer, electrically connecting the driver, the panel assembly, the electromagnetic wave shield layer, the cover, and the case in order for the electromagnetic wave shield layer to shield the electromagnetic waves, wherein the driver, the panel assembly, the electromagnetic wave shield layer, the reflection-preventing film, and the cover are disposed in an order of the driver, the panel assembly, the electromagnetic wave shield layer, the reflection-preventing film, and the cover, from the case.

2. The display apparatus as claimed in claim 1, wherein the electrode connectors are provided at edge areas of the electromagnetic wave shield layer.

3. The display apparatus as claimed in claim 1, wherein the reflection-preventing film cuts off near infrared rays emitted from the panel assembly, and prevents the reflection of light of image signals from the light emitted.

4. The display apparatus as claimed in claim 1, wherein the reflection-preventing film is formed either by laminating an anti-reflection film or coating hardened resin.

5. The display apparatus as claimed in claim 1, wherein the noise signals cut off by the reflection-preventing film correspond to wavelengths ranging from approximately 630 nm to 640 nm.

6. The display apparatus as claimed in claim 1, wherein the panel assembly includes a front substrate, electrode layers, and a rear substrate, the driver drives the electrode layers, and the electromagnetic shield layer shields electromagnetic waves generated from the electrode layers.

7. A display apparatus with a PDP, comprising:
a driver provided between a case and a panel assembly to drive electrode layers;
a metal conductive mesh attached in a predetermined size on an outer surface of the panel assembly, shielding electromagnetic waves generated from the panel assembly;
a reflection-preventing film disposed on an outer surface of the metal conductive mesh, cutting off noise signals out of light emitted from the panel assembly;
a cover coupled to come in contact with predetermined stepped areas of the panel assembly; and
electrode connectors provided at a predetermined area of the metal conductive mesh, and electrically connecting the driver, the panel assembly, the metal conductive mesh, the cover, and the case in order for the metal conductive mesh to shield the electromagnetic wave, wherein the driver, panel assembly, metal conductive mesh, reflection-preventing film, and cover are disposed in an order of the driver, the panel assembly, the metal conductive mesh, the reflection-preventing film, and the cover, from the case.

8. The display apparatus as claimed in claim 7, wherein the electrode connectors include first and second electrode connectors provided at opposing edge areas of the metal conductive mesh.

9. The display apparatus as claimed in claim 7, wherein the reflection-preventing film cuts off near infrared rays emitted from the panel assembly, and prevents the reflection of light for image signals out of emitted light.

10. The display apparatus as claimed in claim 7, wherein the metal conductive mesh is a photo engraved etched metal layer having a mesh shape.

11. A display apparatus with a plasma display panel (PDP), comprising:
a panel assembly; and
an electromagnetic shield layer disposed on the panel assembly such that the electromagnetic shield layer is in contact with the panel assembly.

12. The display apparatus as claimed in claim 11, wherein the electromagnetic shield layer is in contact with a front substrate of the panel assembly.

13. The display apparatus as claimed in claim 12, wherein the electromagnetic shield layer includes a transparent conductive coat.

14. The display apparatus as claimed in claim 13 further comprising a reflection-preventing film disposed on a top surface of the electromagnetic wave shield layer, cutting off noise signals of light emitted from the panel assembly.

15. A display apparatus with a plasma display panel (PDP), comprising:
a panel assembly; and
a metal conductive mesh disposed on the panel assembly such that the metal conductive mesh is in contact with the panel assembly.

16. The display apparatus as claimed in claim 15, wherein the metal conductive mesh is in contact with a front substrate of the panel assembly.

17. The display apparatus as claimed in claim 16 further comprising a reflection-preventing film disposed on an outer surface of the metal conductive mesh, cutting off noise signals of light emitted from the panel assembly.
